(19) United States
(12) Patent Application Publication
(10) Pub. No.: US 2007/0028788 A1
(43) Pub. Date: Feb. 8, 2007

(54) Printing unit comprising a rapidly exchangeable roller mandrel of a printing roller or screen roller

(76) Inventors: Dietmar Koopmann, Lienen (DE); Gunter Rogge, Lienen (DE)

Correspondence Address: JACOBSON HOLMAN PLLC, 400 SEVENTH STREET N.W., SUITE 600, WASHINGTON, DC, 20004, US

(21) Appl. No.: 10/571,318

(22) PCT Filed: Sep. 2, 2004
(86) PCT No.: PCT/EP04/09782

§ 371 Date: Mar. 9, 2006

(30) Foreign Application Priority Data
Sep. 9, 2003 (DE) 103 41 850.4

(51) Int. Cl. B41F 5/00

(52) U.S. Cl. 101/216

(57) ABSTRACT

The present invention relates to a printing unit comprising at least one exchangeable roller mandrel (5) of a printing or screen roller, a coupling device (7), which occupies a usually front coupling location (16) of the roller mandrel (5) at the receiving location (13) of the coupling device (7), and which transmits the torque, which is necessary for rotating the roller mandrel (5), to said roller mandrel (5). To this end, the coupling device (7) and the roller mandrel (5) are formed in such a manner that the coupling location (16) of the roller mandrel (5) can be brought to the receiving location of the coupling device (7) by an axial motion (1) of the roller mandrel (5).

The invention provides that either the roller mandrel (5), at its coupling location or the receiving location (20) [sic; 13] of the coupling device (7), tapers in the axial direction of the roller mandrel (5).

The present invention relates to a printing unit according to the preamble of the main claim 1.

Printing units of this kind are already known. Such printing units often comprise a screen roller, which receives printing ink from an ink fountain. An adjacent printing roller takes over the ink from the screen roller and transfers it onto the print substrate. The described rollers comprise roller mandrels, which are suitable for receiving roller sleeves. These roller sleeves can be pulled off and slid back on rapidly and easily by the respective roller mandrel for the purpose of an order change. Therefore, the respective roller mandrel itself is usually supported at one end. The torque necessary for the rotation is usually transferred onto the roller in the region of this first bearing. For this purpose, the roller mandrel is mostly equipped with a driving gear wheel. However, other torque-generating or torque-transferring components can also be used. Since the component transferring the torque is subject to wear, this component must be exchanged after a certain period of operation. This component is therefore designed as a coupling device, to which the roller mandrel with its mostly front coupling location can be coupled. For the purpose of the coupling, the roller mandrel is brought to the receiving location of the coupling device by an axial motion. However, such an axial displacement of the roller mandrel is possible only if the printing roller is supported at one end. However, the second end of the roller mandrel can be supported in a removable additional bearing during the printing operation. Such additional bearings can usually be dragged down in the axial direction from the printing roller in order to then be displaced radially from the printing roller.

In known rollers of the described kind, the coupling device comprises clamping elements, which can be clamped with the help of screws. Using such clamping elements, radial forces can be applied so that the roller mandrel, which was previously positioned centrally between the circularly arranged clamping elements, is held in a clamped manner.

However, what is disadvantageous here is that for a safe and even clamping, a series of screws must be turned. This approach takes up a lot of time.

The object of the present invention is therefore to suggest a generic printing unit, in which the roller mandrel of the printing or screen roller can be exchanged essentially rapidly.

This object is solved by a printing unit, which is characterized in the typical features of claim 1.

Thus either the roller mandrel at its coupling location or the coupling device at its receiving location tapers. In this manner it is possible to create a torque-proof connection between the coupling device and the roller mandrel using the axial motion of the roller mandrel. Simultaneously a centering of the roller mandrel takes place. After this centering, the principal inertial axis of the roller mandrel aligns exactly with the rotation axis of the coupling device.

In a particularly preferred embodiment of the present invention, the coupling device, which occupies the coupling location of the roller mandrel at the receiving location of the coupling device, clasps a bearing journal using a fastener. This fastener engages in the radial direction centrally at the end of the roller mandrel. This fastener can be a screw, which penetrates a bearing journal through a central borehole and can be screwed in into a central internal thread, which is turned in into the end of the roller mandrel. By turning the screw, the roller mandrel is then moved in the axial direction till the roller mandrel is non-rotatably connected to the coupling device.

Additional embodiments of the invention are specified in the further dependent claims and the drawing. The individual figures illustrate:

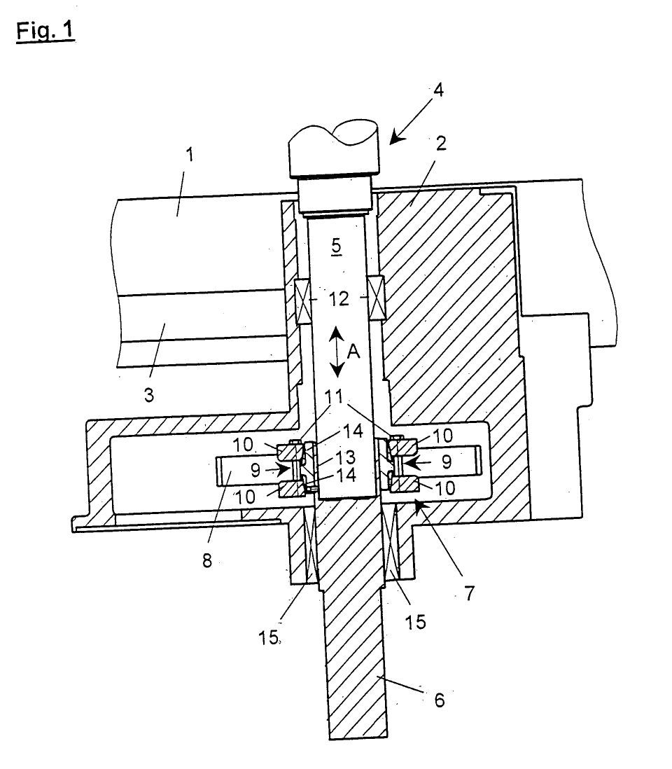

FIG. 1 Top view of a horizontal section of a printing unit according to prior art

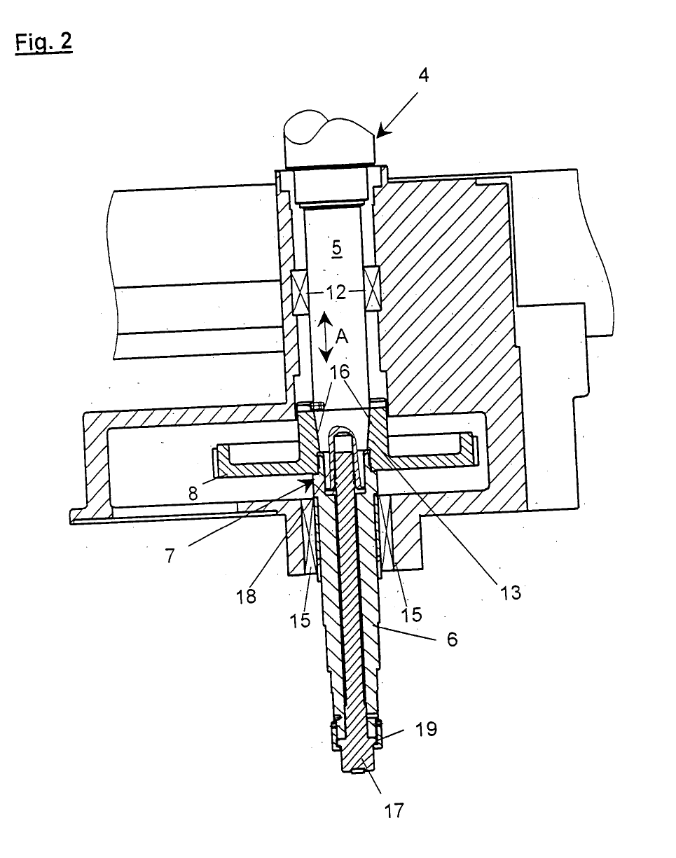

FIG. 2 Top view of a horizontal section of a printing unit according to the invention

FIG. 1 illustrates a top view of a printing unit according to prior art, wherein the figure is limited to the illustration of the driving side of a printing or screen roller. The roller rack 2 is displaceable along a guide rail 3 relative to the printing unit frame 1. The printing unit frame 1 is connected to the machine frame (not illustrated). By the displacement of the roller rack 2, the roller 4 can be positioned against another roller or against the impression cylinder supported in the machine frame, wherein the print substrate is guided on said impression cylinder, as is common, for example, in flexographic printing.

The roller 4 comprises a roller mandrel 5, on which it is possible to slide on a roller sleeve (not illustrated). In order to set the roller mandrel 5 into rotation for the printing operation, the roller mandrel can be coupled to the bearing journal 6. The bearing journal 6 is a component of a coupling device 7. Furthermore, this coupling device 7 comprises a driving gear wheel 8 and clamping elements 9. The driving gear wheel 8 comprises on its front sides recesses, each of which is connected to a borehole. A clamping jaw 10 of the clamping element 9 is inserted into each recess. Every two opposite clamping jaws 10 can be moved on one another with the help of a screw 11. The clamping jaws 10 comprise on the side turned towards the bearing journal 6 chamfers, which run on complementary chamfers 14 of the driving gear wheel 8.

If the roller mandrel is to be connected to the coupling device 7, the roller mandrel is first conveyed using the needle bearing 12 along the double arrow A towards the bearing journal 6 and is inserted into a receiving location 13 of the bearing journal 6, said receiving location 13 being designed as a borehole. Subsequently, the clamping jaws 10 are screwed together. Since the clamping jaws 10 run on the chamfers 14 of the driving gear wheel 8, the driving gear wheel 8 and the bearing journal 6 are pressed together in the region of the receiving location 13. In this way, the roller mandrel 5 is non-rotatably connected to the bearing journal 6. Simultaneously, the driving gear wheel 8 is also pressed non-rotatably onto the bearing journal 6. The bearing journal 6 is supported in the bearing 15, so that the printing roller 4 is supported in two bearings 12, 15 in its assembled state.

FIG. 2 illustrates a roller 4 of a printing unit according to the invention. The principal structure of the printing unit does not differ from that known from prior art. The roller mandrel 5 comprises on its end that is turned towards the bearing journal 6 a conical taper 16 serving as a coupling location. The driving gear wheel 8 comprises a borehole whose diameter reduces with increasing depth complementarily to the conical taper 16 of the roller mandrel 5. The borehole serves as the receiving location 13. The driving gear wheel 8 is stationary though detachably connected to the bearing journal 6. In another embodiment (not illustrated), the receiving location 13 can be inserted into the bearing journal 6.

The bearing journal 6 comprises a central through hole into which a clamping screw 17 is inserted. This clamping screw 17 projects above the bearing journal 6 on the latter=s front side, which is turned towards the roller mandrel 5, so that the clamping screw 17 can set in place into the threaded hole 18 on the front side of the roller mandrel 5, said front side being turned towards the bearing journal 6. By screwing together the clamping screw 17 with the roller mandrel 5, the roller mandrel is non-rotatably connected to the bearing journal 6. Due to the conical taper 16 and the borehole complementary to the former in the driving gear wheel 8 and/or in the bearing journal 6, a centering of the roller mandrel 5 takes place simultaneously. The thus assembled roller is provided with double bearing using the bearing 15 and/or the needle bearing 12.

The clamping screw 17 can be held axially non-displaceably relative to the bearing journal 6 with the help of a sleeve 19, which is permanently connected to the bearing journal 6. In this way, it is possible by loosening the clamping screw 17, to press the roller mandrel 5 out of the borehole in the driving gear wheel 8.

List Of Reference Symbols

| | |
|---|---|
| 1 | Printing unit frame |
| 2 | Roller rack |
| 3 | Guide rail |
| 4 | Roller |
| 5 | Roller mandrel |
| 6 | Bearing journal |
| 7 | Coupling device |
| 8 | Driving gear wheel |
| 9 | Clamping element |
| 10 | Clamping jaws |
| 11 | Screw |
| 12 | Needle bearing |
| 13 | Receiving location |
| 14 | Chamfer |
| 15 | Bearing |
| 16 | Cone-shaped taper |
| 17 | Clamping screw |
| 18 | Threaded borehole |
| 19 | Sleeve |
| A | Direction of the displacement of the roller mandrel 5 for |
| | coupling or uncoupling to/from the bearing journal 6 |

1. A printing unit having
at least one replaceable roll mandrel (5) of a printing roll or anilox roll, which (5) may be mounted on one end,
a coupling device (7), which receives a typically front-side coupling point (16) of the roll mandrel (5) on its (7) receiving point (13) and transmits the torque required for rotating the roll mandrel (5) thereto (5),
the coupling device (7) and the roll mandrel (5) being implemented in such a way that the coupling point (16) of the roll mandrel (5) may be brought to the receiving point of the coupling device (7) through an axial movement (A) of the roll mandrel (5), characterized in that either the roll mandrel (5), at its coupling point (16), or the receiving point (13) of the coupling device (7) tapers in the axial direction of the roll mantle (5).

2. Printing unit according to claim 1
characterized in that
either the roller mandrel (5) at its coupling location (16) or the receiving location (13) of the coupling device (7) tapers conically in the axial direction of the roller mandrel (5).

3. Printing unit according to claim 1
characterized in that
the coupling location (16) of the roller mandrel (5) tapers and is located at one end of the roller mandrel (5).

4. Printing unit according to claim 1
characterized in that
the coupling device (7), which occupies the coupling location (16) of the roller mandrel at the receiving location (13) of the coupling device (7) clasps a bearing journal (6) with a fastener (17) that (17) engages in the radial direction centrally at the end of the roller mandrel (5).

5. Printing unit according to claim 2
characterized in that
the coupling location (16) of the roller mandrel (5) tapers and is located at one end of the roller mandrel (5).

6. Printing unit according to claim 2
characterized in that
the coupling device (7), which occupies the coupling location (16) of the roller mandrel at the receiving location (13) of the coupling device (7) clasps a bearing journal (6) with a fastener (17) that (17) engages in the radial direction centrally at the end of the roller mandrel (5).

7. Printing unit according to claim 3
characterized in that
the coupling device (7), which occupies the coupling location (16) of the roller mandrel at the receiving location (13) of the coupling device (7) clasps a bearing journal (6) with a fastener (17) that (17) engages in the radial direction centrally at the end of the roller mandrel (5).
